(19) United States
(12) Patent Application Publication
(10) Pub. No.: US 2011/0231079 A1
(43) Pub. Date: Sep. 22, 2011

(54) METHOD AND DEVICE FOR OPERATING AN INTERNAL COMBUSTION ENGINE

(76) Inventors: Tino Arlt, Regensburg (DE); Rolf Brück, Bergisch Gladbach (DE); Gerd Rösel, Regensburg (DE)

(21) Appl. No.: 13/129,469

(22) PCT Filed: Nov. 6, 2009
(86) PCT No.: PCT/EP2009/064780

§ 371 Date: May 16, 2011

(30) Foreign Application Priority Data
Nov. 19, 2008 (DE) 10 2008 058 010.4

(51) Int. Cl. F02D 28/00; F02D 41/30; F01N 3/18

(52) U.S. Cl. 701/103; 701/102

(57) ABSTRACT

According to a current operating state (BZ) of an internal combustion engine and/or a specified particle number emission limit (PE), a minimum hydrocarbon concentration (HCMK) of a combustion chamber exhaust gas of the internal combustion engine that is required to comply with the specified particle number emission limit is determined. An operation (B) of the internal combustion engine is specified to achieve a hydrocarbon concentration (HCK) of the combustion chamber exhaust gas that is at least as large as the determined minimum hydrocarbon concentration (HCMK).

### CROSS-REFERENCE TO RELATED APPLICATIONS

This application is a U.S. National Stage Application of International Application No. PCT/EP2009/064780 filed Nov. 6, 2009, which designates the United States of America, and claims priority to German Application No. 10 2008 058 010.4 filed Nov. 19, 2008, the contents of which are hereby incorporated by reference in their entirety.

### TECHNICAL FIELD

The invention relates to a method and a device for operating an internal combustion engine, in particular a spark-ignition or diesel internal combustion engine of a motor vehicle.

### BACKGROUND

During the operation of a spark-ignition or diesel internal combustion engine, exhaust gas is generally produced which contains for example hydrocarbons, carbon monoxide, nitrogen oxides and particles, and the emissions of which are subject to legal regulations. There are limit values in particular for the emissions of hydrocarbons and of a particle mass. To purify the exhaust gas in order to adhere to the limit values, an exhaust-gas purification system is provided which comprises for example at least one exhaust-gas catalytic converter and if appropriate a particle filter.

### SUMMARY

According to various embodiments, a method and a device for operating an internal combustion engine can be provided which allow the internal combustion engine to operate with low emissions.

According to an embodiment, in a method for operating an internal combustion engine, a hydrocarbon minimum concentration of a combustion chamber exhaust gas of the internal combustion engine, which is required for adhering to a predefined particle count emissions limit value, is determined as a function of a present operating state of the internal combustion engine and/or the predefined particle count emissions limit value, and an operating mode of the internal combustion engine is predefined so as to attain a hydrocarbon concentration of the combustion chamber exhaust gas at least as high as the determined hydrocarbon minimum concentration.

According to a further embodiment, the predefining of the operating mode of the internal combustion engine so as to attain the hydrocarbon concentration may comprise a predefined injection strategy for an injection of fuel. According to a further embodiment, the predefined injection strategy may comprise at least one post-injection of fuel into at least one combustion chamber of the internal combustion engine and/or into a combustion chamber untreated gas of the internal combustion engine downstream of the at least one combustion chamber of the internal combustion engine, in such a way that the post-injected fuel remains substantially unburned. According to a further embodiment, the hydrocarbon minimum concentration may amount to approximately 4000 to 5000 parts per million in the case of a cold internal combustion engine and amounts to at least 2500 parts per million in the case of a warm internal combustion engine. According to a further embodiment, at least one exhaust-gas catalytic converter can be provided downstream of at least one combustion chamber of the internal combustion engine, and in which at least one of the at least one exhaust-gas catalytic converter is, within a predefined time period, brought at least to its operating temperature for the conversion of hydrocarbons, wherein during the predefined time period the operating mode of the internal combustion engine is predefined so as to adhere to a predefined hydrocarbon emissions limit value, and after the predefined time period has elapsed, the operating mode of the internal combustion engine is predefined so as to attain the hydrocarbon concentration of the combustion chamber exhaust gas at least as high as the determined hydrocarbon minimum concentration. According to a further embodiment, the predefined time period can be predefined as a function of a temperature of the at least one exhaust-gas catalytic converter and/or an exhaust-gas temperature and/or an exhaust-gas mass flow and/or a particle count in the combustion chamber exhaust gas and/or the predefined particle count emission limit value. According to a further embodiment, the predefined time period may last for a maximum of 20 seconds. According to a further embodiment, after the predefined time period has elapsed, the operating mode of the internal combustion engine can be predefined so as to attain an air ratio of one at the inlet side of the at least one exhaust-gas catalytic converter.

According to various embodiments, a device for operating an internal combustion engine, can be designed to determine a hydrocarbon minimum concentration of a combustion chamber exhaust gas of the internal combustion engine, which is required to adhere to a predefined particle count emissions limit value, as a function of the present operating state of the internal combustion engine and/or the predefined particle count emissions limit value, and to predefine an operating mode of the internal combustion engine so as to attain a hydrocarbon concentration of the combustion chamber exhaust gas at least as high as the determined hydrocarbon minimum concentration.

### BRIEF DESCRIPTION OF THE DRAWINGS

Exemplary embodiments will be explained below on the basis of the schematic drawings, in which:

FIG. 1 shows an internal combustion engine having an exhaust tract,

FIG. 2 shows a first flow diagram and

FIG. 3 shows a second flow diagram.

Elements of identical design or function are provided with the same reference numerals throughout.

### DETAILED DESCRIPTION

According to various embodiments, in a method and a corresponding device for operating an internal combustion engine, a hydrocarbon minimum concentration of a combustion chamber exhaust gas of the internal combustion engine, which is required for adhering to a predefined particle count emissions limit value, is determined as a function of a present operating state of the internal combustion engine and/or the predefined particle count emissions limit value. An operating mode of the internal combustion engine is predefined so as to attain a hydrocarbon concentration of the combustion chamber exhaust gas at least as high as the determined hydrocarbon minimum concentration.

The various embodiments are based on the realization that a high hydrocarbon concentration at least as high as the hydrocarbon minimum concentration can result in a lower particle count in the exhaust gas of the internal combustion engine than is attained with a lower hydrocarbon concentration below the hydrocarbon minimum concentration. This is possible for example on account of the fact that particles and in particular small particles composed substantially of incompletely burned hydrocarbons bind together to form larger particles, as a result of which the number of particles present in the exhaust gas is reduced for an unchanged total mass of the particles. The expression “small particles” means for example particles of the order of magnitude of approximately 20 nm-80 nm, whereas the expression “larger particles” means for example particles of the order of magnitude of approximately 200 nm-400 nm. The higher the hydrocarbon concentration in the exhaust gas, the higher basically is the probability that particles impinge on one another and bind together to form a larger particle. This may be utilized to reduce the number of particles in the exhaust gas and thereby adhere to the particle count emissions limit value. By increasing the hydrocarbon concentration above the hydrocarbon minimum concentration, the particle count emissions limit value can be adhered to in a very simple manner.

The hydrocarbon concentration and the hydrocarbon minimum concentration refer to a number of hydrocarbon particles within a predefined volume, and are specified for example in parts per million, that is to say hydrocarbon particles per million particles within the predefined volume. The hydrocarbon concentration and the hydrocarbon minimum concentration may however be specified differently. The hydrocarbon concentration and the hydrocarbon minimum concentration in particular do not refer to a mass of individual hydrocarbon particles or to the total mass of the hydrocarbon particles.

In an embodiment, the predefining of the operating mode of the internal combustion engine to attain the hydrocarbon concentration comprises a predefined injection strategy for an injection of fuel. The advantage is that the operating mode of the internal combustion engine can be predefined in a very simple manner by the predefined injection strategy so as to attain the hydrocarbon concentration. The predefined injection strategy may in particular comprise a time and/or a frequency of an injection and/or an injection quantity. Furthermore, the predefined injection strategy may also comprise for example measures for influencing a spray formation. The predefined injection strategy is designed and intended to increase the hydrocarbon concentration in the combustion chamber exhaust gas.

In this connection, it is advantageous for the predefined injection strategy to comprise at least one post-injection of fuel into at least one combustion chamber of the internal combustion engine and/or into a combustion chamber untreated exhaust gas of the internal combustion engine downstream of the at least one combustion chamber of the internal combustion engine, in such a way that the post-injected fuel remains substantially unburned. The advantage is that the hydrocarbon concentration can be increased in a very simple and reliable manner by means of such a post-injection of fuel. The post-injection may also be referred to as a late injection, wherein the injection takes place so late in relation to a cycle of the internal combustion engine that the post-injected fuel remains substantially unburned, that is to say at least a part of the post-injected fuel remains unburned, that is to say is not ignited and therefore does not take part in the combustion.

In a further embodiment, the hydrocarbon minimum concentration amounts to approximately 4000 to 5000 parts per million in the case of a cold internal combustion engine and amounts to at least 2500 parts per million in the case of a warm internal combustion engine. The hydrocarbon particle count can be reliably reduced in this way.

In a further embodiment, at least one exhaust-gas catalytic converter is provided downstream of the at least one combustion chamber of the internal combustion chamber. At least one of the at least one exhaust-gas catalytic converter is, within a predefined time period, brought at least to its operating temperature for the conversion of hydrocarbons. During the predefined time period, the operating mode of the internal combustion engine is predefined so as to adhere to a predefined hydrocarbon emissions limit value. After the predefined time period has elapsed, the operating mode of the internal combustion engine is predefined so as to attain the hydrocarbon concentration of the combustion chamber exhaust gas at least as high as the determined hydrocarbon minimum concentration. This has the advantage that the predefined hydrocarbon emissions limit value can be reliably adhered to in particular during a starting process of the internal combustion engine and in particular when the internal combustion engine is still cold, and both the predefined hydrocarbon emissions limit value and also the predefined particle count emissions limit value can be reliably adhered to after the operating temperature of the exhaust-gas catalytic converter is reached. It is thus possible overall for the internal combustion engine to be operated with low emissions.

In this connection, it is advantageous for the predefined time period to be predefined as a function of a temperature of the at least one exhaust-gas catalytic converter and/or an exhaust-gas temperature and/or an exhaust-gas mass flow and/or a particle count in the combustion chamber exhaust gas and/or the predefined particle count emissions limit value. The advantage is that, in this way, the predefined time period may be selected to be as long as necessary and as short as possible in order to be able as early as possible to increase the hydrocarbon concentration in the combustion chamber exhaust gas for the reduction of the particle count, but without exceeding the predefined hydrocarbon emissions limit value. In particular, the predefined time period may also be predefined as being zero if the exhaust-gas catalytic converter is already at its operating temperature. Furthermore, in general, the predefined time period can be predefined to be shorter the higher the exhaust-gas temperature and/or the exhaust-gas mass flow is. Furthermore, the predefined time period may be predefined to be short or zero if, in the present operating state of the internal combustion engine, the particle count in the combustion chamber exhaust gas is so low that the predefined particle count emissions limit value can be adhered to even without an increase, or by means of only a slight increase, in the hydrocarbon concentration in the combustion chamber exhaust gas for the reduction of the particle count.

In a further embodiment, the predefined time period lasts at most 20 seconds. In this way, the number of particles generated during the predefined time period can be kept low and the predefined particle count emissions limit value can be reliably adhered to. As a result of the particularly fast heating of the exhaust-gas catalytic converter to its operating temperature within a maximum of 20 seconds, the increase in the hydrocarbon concentration in the combustion chamber exhaust gas for the reduction of the particle count can begin particularly early, without exceeding the hydrocarbon emissions limit value. Both the predefined hydrocarbon emissions limit value and also the predefined particle count emissions limit value can thus be reliably adhered to. Overall, the internal combustion engine can thus be operated with low emissions.

In a further embodiment, after the predefined time period has elapsed, the operating mode of the internal combustion engine is predefined so as to attain an air ratio of one at the inlet side of the at least one exhaust-gas catalytic converter. The advantage is that, in this way, it is possible in particular for the hydrocarbon emissions limit value to be reliably adhered to.

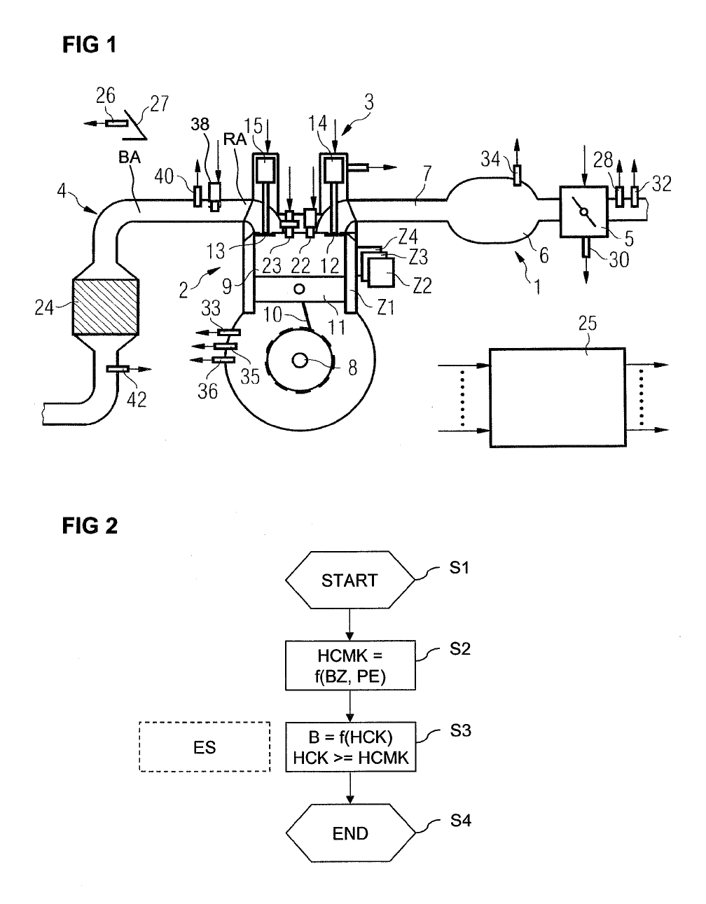

An internal combustion engine (FIG. 1) comprises an intake tract 1, an engine block 2, a cylinder head 3 and an exhaust tract 4. The intake tract 1 preferably comprises a throttle flap 5, a collector 6 and an intake pipe 7, which, in the direction of at least one cylinder Z1-Z4, leads via an inlet duct into a combustion chamber 9 of the engine block 2. The engine block 2 comprises a crankshaft 8 which is coupled to the piston 11 of the cylinder Z1-Z4 via a connecting rod 10. The internal combustion engine is arranged preferably in a motor vehicle.

The cylinder head 3 comprises a valve drive having at least one gas inlet valve 12, at least one gas outlet valve 13 and valve drives 14, 15. The cylinder head 3 also comprises an injection valve 22 and if appropriate a spark plug 23. The injection valve 22 may also alternatively be arranged in the intake pipe 7.

The exhaust tract 4 comprises at least one exhaust-gas catalytic converter 24 which is designed preferably as a three-way catalytic converter and which belongs to an exhaust-gas purification system or emissions reduction system of the internal combustion engine. The exhaust-gas catalytic converter 24 is suitable in particular for storing and discharging oxygen as a function of an oxygen loading level of the exhaust-gas catalytic converter 24. If the oxygen loading level is at a maximum, no further oxygen can be accommodated by the exhaust-gas catalytic converter. The exhaust-gas purification or emissions reduction system, in particular in the case of a diesel internal combustion engine, may also comprise a particle filter for filtering in particular large, that is to say high-mass particles out of the exhaust gas and/or a recirculation of exhaust gases from the exhaust tract 4 and/or the combustion chamber 9 into the intake tract 1 or the combustion chamber 9. In the case of the recirculation of the exhaust gases, an exhaust-gas recirculation rate may be set for example by means of a valve overlap phase in which the gas inlet valve 12 and the gas outlet valve 13 are simultaneously open. The recirculation of the exhaust gases results, for example, in a lower combustion temperature during a combustion process in the combustion chamber 9 than is obtained without the recirculation of the exhaust gases. The lower combustion temperature can lead to a lower level of pollutant production during the combustion process than is obtained at a higher combustion temperature.

A control device 25 is provided which is assigned sensors which measure different measurement variables and which in each case determine the value of the measurement variable. Operating variables comprise the measurement variables and variables of the internal combustion engine derived from said measurement variables. The control device 25 determines, as a function of at least one of the operating variables, at least one actuating variable which are then converted into one or more actuating signals for controlling the actuators by means of corresponding actuating drives. The control device 25 may also be referred to as a device for operating the internal combustion engine.

The sensors are for example a pedal position transducer 26, which detects an accelerator pedal position of an accelerator pedal 27, an air mass sensor 28, which detects an air mass flow upstream of the throttle flap 5, a throttle flap position sensor 30, which detects a degree of opening of the throttle flap 5, a first temperature sensor 32, which detects an intake air temperature, a second temperature sensor 33, which detects a cooling water temperature, a third temperature sensor 34, which detects an oil temperature, an intake pipe pressure sensor 34, which detects an intake pipe pressure in the collector 6, a crankshaft angle sensor 36, which detects a crankshaft angle, which is then assigned a rotational speed. Furthermore, an exhaust-gas probe 40 is preferably arranged in the exhaust tract upstream of the exhaust-gas catalytic converter 24, the measurement signal of which exhaust-gas probe, taking into consideration a gas propagation time from the combustion chamber 9 to the exhaust-gas probe 40, is representative of an air/fuel ratio in the combustion chamber 9 or in a combustion chamber untreated exhaust gas RA directly downstream of the combustion chamber 9 or in a combustion chamber exhaust gas BA directly upstream of the exhaust-gas catalytic converter 24. Furthermore, a further exhaust-gas probe 42 may be provided downstream of the exhaust-gas catalytic converter 24, by means of which further exhaust-gas probe for example the oxygen loading capacity of the exhaust-gas catalytic converter 24 can be checked. The exhaust-gas probes 40, 42 upstream and/or downstream of the exhaust-gas catalytic converter 24 are further elements of the exhaust-gas purification or emissions reduction system of the internal combustion engine. Depending on the embodiment, any desired subset of said sensors may be provided, or additional sensors may also be provided.

The actuators are for example the throttle flap 5, the gas inlet and gas outlet valves 12, 13, the injection valve 22 and/or the spark plug 23.

Aside from the cylinder Z1, further cylinders Z2-Z4 are preferably provided which are assigned corresponding actuators.

FIG. 2 shows a first flow diagram of a program for operating the internal combustion engine, which can preferably be executed in the control device 25. The program begins in a step S1 in which for example preparations are made and/or initializations are carried out. In a step S2, a present operating state BZ of the internal combustion engine is preferably determined. The present operating state BZ may be determined for example as a function of the operating variables of the internal combustion engine, in particular for example as a function of the cooling water temperature or the oil temperature, that is to say substantially a temperature of the internal combustion engine, and/or an exhaust-gas temperature and/or a temperature of the at least one exhaust-gas catalytic converter 24 and/or an exhaust-gas mass flow and/or a present particle count N generated during the combustion and/or a hydrocarbon concentration HCK presently generated during the combustion. The present operating state BZ may however also be determined as a function of other or further operating variables and/or other variables.

A hydrocarbon minimum concentration HCMK of the combustion chamber untreated exhaust gas RA or combustion chamber exhaust gas BA of the internal combustion engine, which is required for adhering to a predefined particle count emissions limit value PE, is determined as a function of the determined present operating state BZ of the internal combustion engine and/or as a function of the predefined particle count emissions limit value PE. The hydrocarbon minimum concentration HCMK amounts to for example approximately 4000 to 5000 parts per million in the case of a cold internal combustion engine and amounts to at least 2500 parts per million in the case of a warm internal combustion engine.

The particles present in the exhaust gas consist substantially of hydrocarbons HC. If the hydrocarbon concentration HCK in the combustion chamber untreated exhaust gas RA or combustion chamber exhaust gas BA is at at least the hydrocarbon minimum concentration HCMK, then the hydrocarbon particles preferably bind together to form larger particles. As a result of the binding-together of a plurality of small particles to form a smaller number of large particles, the particle count N in the exhaust gas is reduced. To achieve this, in a step S3, an operating mode B of the internal combustion engine is predefined so as to attain the hydrocarbon concentration HCK of the combustion chamber untreated exhaust gas RA or of the combustion chamber exhaust gas BA at least as high as the determined hydrocarbon minimum concentration HCMK. The resulting larger particles may be removed from the exhaust gas for example by means of particle filters.

The operating mode B of the internal combustion engine to attain such a hydrocarbon concentration HCK preferably comprises a predefined injection strategy ES, that is to say an injection of fuel is carried out or modified especially for the purpose in order to increase the hydrocarbon concentration HCK. In general, the predefined injection strategy ES therefore opposes the efforts to keep the hydrocarbon concentration HCK in the exhaust gas as low as possible in order to be able to reliably adhere to a predefined hydrocarbon emissions limit value HCE. The predefined injection strategy ES may in particular comprise a post-injection or late injection of fuel, wherein in particular an injection time or else injection location are selected such that the post-injected fuel does not take part in the combustion engine, that is to say is not ignited, but rather at least a part of the post-injected fuel remains unburned in the combustion chamber untreated exhaust gas RA or combustion chamber exhaust gas BA. For example, a further injection valve 38 may be provided downstream of the combustion chamber 9 and upstream of the at least one exhaust-gas catalytic converter 24 for the post-injection of fuel into the combustion chamber untreated exhaust gas RA. It may however likewise be provided for example that for example an additional, late injection, that is to say post-injection, of fuel into the combustion chamber 9 is carried out by means of the injection valve 22, specifically so late in relation to a cycle of the internal combustion engine that the post-injected fuel remains substantially unburned. For the increase of the hydrocarbon concentration HCK in the combustion chamber untreated exhaust gas RA or combustion chamber exhaust gas BA, it is advantageous in particular for the post-injected fuel to be particularly finely distributed, that is to say for a particularly large number of fuel droplets to be produced. This increases the probability of the impacting and binding-together of hydrocarbon particles. Other measures for increasing the hydrocarbon concentration HCK in the combustion chamber untreated exhaust gas RA or in the combustion chamber exhaust gas BA may however likewise be provided.

The program ends in a step S4, and is preferably carried out repeatedly.

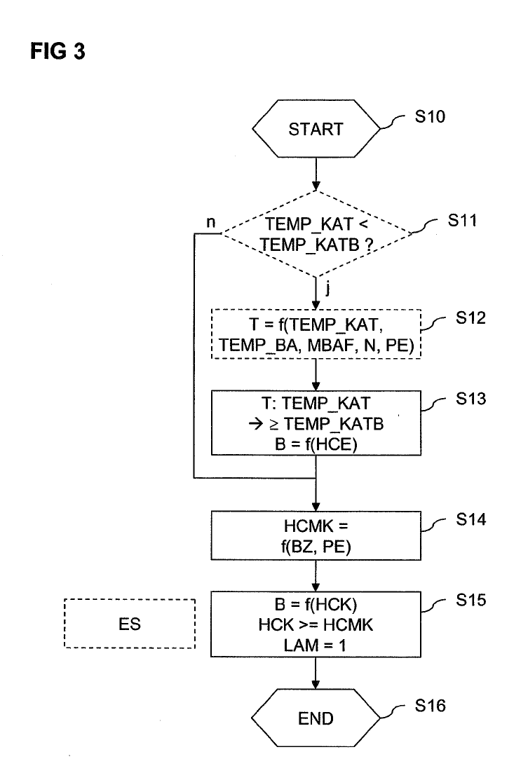

FIG. 3 shows a second flow diagram of the program which has been expanded in relation to that illustrated in FIG. 2. The program begins in a step S10. A step S11 may be provided for detecting the temperature TEMP_KAT of the at least one exhaust-gas catalytic converter 24 and in particular of a close-coupled exhaust-gas catalytic converter and for checking whether said at least one exhaust gas catalytic converter 24 is already at its operating temperature TEMP_KATB for converting hydrocarbons HC. If this is not the case, said at least one exhaust-gas catalytic converter 24 is brought at least to its operating temperature TEMP_KATB within a predefined time period T. A step S12 may be provided for determining the required time period and for predefining said determined time period as the predefined time period T. The predefined time period T is in particular determined and predefined as a function of the present temperature TEMP_KAT of the at least one exhaust-gas catalytic converter 24 and/or the exhaust-gas temperature TEMP_BA and/or the exhaust-gas mass flow MBAF and/or the particle count N in the combustion chamber untreated exhaust gas RA or combustion chamber exhaust gas BA and/or the predefined particle count emissions limit value PE. The predefined time period T lasts preferably at most twenty seconds.

In a step S13, at least one of the at least one exhaust-gas catalytic converter 24, in particular the exhaust-gas catalytic converter 24 closest to the engine, is, within the predefined time period T, brought at least to its operating temperature TEMP_KATB for the conversion of hydrocarbons HC. Here, during the predefined time period T, the operating mode B of the internal combustion engine is predefined so as to adhere to the predefined hydrocarbon emissions limit value HCE, that is to say, the predefined injection strategy ES for increasing the hydrocarbon concentration HCK is preferably not used during the predefined time period T. In a step S14, which corresponds to the step S2, the hydrocarbon minimum concentration HCMK is determined. In a step S15, which substantially corresponds to the step S3, after the predefined time period T has elapsed, the operating mode B of the internal combustion engine is predefined so as to attain the hydrocarbon concentration HCK of the combustion chamber untreated exhaust gas RA or combustion chamber exhaust gas BA at least as high as the determined hydrocarbon minimum concentration HCMK. The reduction in the particle count N can be attained in this way. The predefined injection strategy ES is preferably utilized in step S15.

The operating mode B of the internal combustion engine and in particular also the predefined injection strategy ES are preferably predefined such that an air ratio LAM of one prevails, that is to say that the air/fuel ratio is stoichiometric, at the inlet side of the at least one exhaust-gas catalytic converter 24, that is to say directly upstream of the at least one exhaust-gas catalytic converter 24. The air ratio LAM can be detected for example as a lambda value by the exhaust-gas probe 40. Provision may for example be made for the combustion in the combustion chamber 9 to be carried out with an excess of oxygen or for oxygen to be supplied after the combustion, for example by means of a valve overlap or by means of a secondary injection of air. By means of the additional introduction of air to increase the hydrocarbon concentration HCK, in particular within the context of the predefined injection strategy ES, the air/fuel ratio is then brought to a value of the air ratio LAM of one. The hydrocarbon emissions limit value can be particularly reliably adhered to in this way. The air ratio LAM of one is preferably attained temporally on average. A periodic variation of the air ratio LAM about the value of one may for example be provided. For the reliable reduction of the hydrocarbons HC in the exhaust-gas catalytic converter 24, it is possible here for example to utilize the oxygen storage capacity thereof.

The program ends in a step S16. The steps S14 and S15 are preferably carried out repeatedly. The steps S10 to S13 are preferably carried out at a start of operation of the internal combustion engine, in particular in the event of a cold start.

What is claimed is:

1. A method for operating an internal combustion engine, the method comprising:
determining a hydrocarbon minimum concentration of a combustion chamber exhaust gas of the internal combustion engine, which is required for adhering to a predefined particle count emissions limit value, as a function of at least one of a present operating state of the internal combustion engine and the predefined particle count emissions limit value, and
predefining an operating mode of the internal combustion engine so as to attain a hydrocarbon concentration of the combustion chamber exhaust gas at least as high as the determined hydrocarbon minimum concentration.

2. The method according to claim 1, wherein the predefining of the operating mode of the internal combustion engine so as to attain the hydrocarbon concentration comprises a predefined injection strategy for an injection of fuel.

3. The method according to claim 2, wherein the predefined injection strategy comprises at least one post-injection of fuel into at least one of: at least one combustion chamber of the internal combustion engine and into untreated exhaust gas of a combustion chamber of the internal combustion engine downstream of the at least one combustion chamber of the internal combustion engine, in such a way that the post-injected fuel remains substantially unburned.

4. The method according to claim 1, wherein the hydrocarbon minimum concentration amounts to approximately 4000 to 5000 parts per million in the case of a cold internal combustion engine and amounts to at least 2500 parts per million in the case of a warm internal combustion engine.

5. The method according to claim 1, wherein at least one exhaust-gas catalytic converter is provided downstream of at least one combustion chamber of the internal combustion engine, and in which
at least one of the at least one exhaust-gas catalytic converter is, within a predefined time period, brought at least to its operating temperature for the conversion of hydrocarbons, wherein during the predefined time period the operating mode of the internal combustion engine is predefined so as to adhere to a predefined hydrocarbon emissions limit value, and
after the predefined time period has elapsed, the operating mode of the internal combustion engine is predefined so as to attain the hydrocarbon concentration of the combustion chamber exhaust gas at least as high as the determined hydrocarbon minimum concentration.

6. The method according to claim 5, wherein the predefined time period is predefined as a function of at least one of: a temperature of the at least one exhaust-gas catalytic converter, an exhaust-gas temperature, an exhaust-gas mass flow, a particle count in the combustion chamber exhaust gas, and the predefined particle count emission limit value.

7. The method according to claim 5, wherein the predefined time period lasts for a maximum of 20 seconds.

8. The method according to claim 5, wherein, after the predefined time period has elapsed, the operating mode of the internal combustion engine is predefined so as to attain an air ratio of one at the inlet side of the at least one exhaust-gas catalytic converter.

9. A device for operating an internal combustion engine, which device is configured
to determine a hydrocarbon minimum concentration of a combustion chamber exhaust gas of the internal combustion engine, which is required to adhere to a predefined particle count emissions limit value, as a function of at least one of the present operating state of the internal combustion engine and the predefined particle count emissions limit value, and
to predefine an operating mode of the internal combustion engine so as to attain a hydrocarbon concentration of the combustion chamber exhaust gas at least as high as the determined hydrocarbon minimum concentration.

10. The device according to claim 9, wherein the predefining of the operating mode of the internal combustion engine so as to attain the hydrocarbon concentration comprises a predefined injection strategy for an injection of fuel.

11. The device according to claim 10, wherein the predefined injection strategy comprises at least one post-injection of fuel into at least one of: at least one combustion chamber of the internal combustion engine and into untreated exhaust gas of a combustion chamber of the internal combustion engine downstream of the at least one combustion chamber of the internal combustion engine, in such a way that the post-injected fuel remains substantially unburned.

12. The device according to claim 9, wherein the hydrocarbon minimum concentration amounts to approximately 4000 to 5000 parts per million in the case of a cold internal combustion engine and amounts to at least 2500 parts per million in the case of a warm internal combustion engine.

13. The device according to claim 9, wherein at least one exhaust-gas catalytic converter is provided downstream of at least one combustion chamber of the internal combustion engine, and wherein
at least one of the at least one exhaust-gas catalytic converter is configured, within a predefined time period, to be brought at least to its operating temperature for the conversion of hydrocarbons, wherein during the predefined time period the operating mode of the internal combustion engine is predefined so as to adhere to a predefined hydrocarbon emissions limit value, and
after the predefined time period has elapsed, the operating mode of the internal combustion engine is predefined so as to attain the hydrocarbon concentration of the combustion chamber exhaust gas at least as high as the determined hydrocarbon minimum concentration.

14. The device according to claim 13, wherein the predefined time period is predefined as a function of at least one of: a temperature of the at least one exhaust-gas catalytic converter, an exhaust-gas temperature, an exhaust-gas mass flow, a particle count in the combustion chamber exhaust gas, and the predefined particle count emission limit value.

15. The device according to claim 14, wherein the predefined time period lasts for a maximum of 20 seconds.

16. The device according to claim 13, wherein, after the predefined time period has elapsed, the operating mode of the internal combustion engine is predefined so as to attain an air ratio of one at the inlet side of the at least one exhaust-gas catalytic converter.

17. A system for operating an internal combustion engine, comprising:
a control device coupled with a plurality of sensors from which an operating state of the internal combustion engine can be determined, wherein the device is operable
to determine a hydrocarbon minimum concentration of a combustion chamber exhaust gas of the internal combustion engine, which is required for adhering to a predefined particle count emissions limit value, as a function of at least one of a present operating state of the internal combustion engine and the predefined particle count emissions limit value, and
predefine an operating mode of the internal combustion engine so as to attain a hydrocarbon concentration of the combustion chamber exhaust gas at least as high as the determined hydrocarbon minimum concentration.

18. The system according to claim 17, wherein the sensors determine operating variables of the internal combustion engine, the operating variables and the control device determines, as a function of at least one of the operating variables, at least one actuating variable which are then converted into one or more actuating signals for controlling the actuators by means of corresponding actuating drives.

19. The system according to claim 18, wherein the sensors are selected from the group consisting of: a pedal position transducer, an air mass sensor, a throttle flap position sensor, a first temperature sensor, which detects an intake air temperature, a second temperature sensor, which detects a cooling water temperature, a third temperature sensor, which detects an oil temperature, an intake pipe pressure sensor, a crankshaft angle sensor, an exhaust-gas probe arranged in an exhaust tract upstream of an exhaust-gas catalytic converter, and a further exhaust-gas probe downstream of the exhaust-gas catalytic converter.

20. The system according to claim 17, wherein the hydrocarbon minimum concentration amounts to approximately 4000 to 5000 parts per million in the case of a cold internal combustion engine and amounts to at least 2500 parts per million in the case of a warm internal combustion engine.
